(19) United States
(12) Patent Application Publication
(10) Pub. No.: US 2026/0364716 A1
(43) Pub. Date: Nov. 19, 2026

(54) DIRECTED ENERGY DEPOSITION PROCESS CONTROL

(71) Applicant: Hyperscale Manufacturing Inc., Hutto, TX (US)

(72) Inventors: Quinlan Yee Shuck, Troy, MI (US); Brian Cox, Florence, TX (US)

(21) Appl. No.: 19/563,385

(22) Filed: Mar. 11, 2026

Related U.S. Application Data
(60) Provisional application No. 63/777,982, filed on Mar. 26, 2025.

(51) Int. Cl. B23K 26/342; B33Y 10/00; B33Y 30/00; B33Y 50/02

(52) U.S. Cl. CPC B23K 26/342; B33Y 10/00; B33Y 30/00; B33Y 50/02

(57) ABSTRACT

A method of printing a three-dimensional part and a three-dimensional printer including a controller configured to perform the method, wherein the method includes defining a tool path for a three-dimensional part to be printed with a microwire in a printer, calculating a solid volume fraction for a plurality of points along the tool path, scaling a light power of a light source to melt the microwire based upon the solid volume fraction determined at each point, and printing the microwire by projecting light at the scaled light power for each point to form a printed part. The solid volume fraction is a percentage of a defined volume that includes a solid material.

### FIELD

The present disclosure is directed to a method and system of controlling a directed energy deposition system.

### BACKGROUND

Three-dimensional printing, like many forms of additive manufacturing, involves the creation of parts by depositing material layer by layer. Each subsequent layer of material is representative of a cross-section of the part. Directed energy deposition is one form of 3D printing that may use metals and metal alloys for forming a three-dimensional part. During the directed energy deposition process, an energy source, such as an electron beam, laser, or arc, is directed towards and impinges upon a feed material.

In laser wire directed energy deposition, wire is used as a feed material. The feed material melts and is deposited either directly on the print bed or on a previously printed layer. Directed energy deposition provides the ability to fabricate parts that are relatively complex and produce parts with metals that may be hard to process using other manufacturing processes. Challenges remain in laser directed energy deposition systems and processes including relatively poor resolution of the parts produced, small laser spot size, and insufficient energy input, reducing throughput rates compared to other methods of additive manufacturing with metal.

Some of these challenges are exacerbated by how the process parameters used in three-dimensional printing are generated. Three-dimensional printing generally uses slicer software to generate a tool path and develop process parameters corresponding to points along the tool path. The slicer software divides computer aided design (CAD) models into layers. The slicer then uses the individual layers to determine the process parameters for that layer. Underlying geometry and materials are not considered in determining the process parameters. This may be problematic because the part geometry and material of underlying layers affect heat dissipation and other bulk part characteristics. In metal components, edges and corners may melt back due to a lack of thermal mass to quickly dissipate heat.

While the current microwire directed energy deposition systems and methods are useful for their intended purpose, there is room in the art for improvements in printer design and methods for producing three-dimensional parts.

### SUMMARY

According to various aspects, the present disclosure relates to a method of printing a three-dimensional part. The method includes defining a tool path for a three-dimensional part to be printed with a microwire in a printer, calculating a solid volume fraction for a plurality of points along the tool path, scaling a light power of a light source to melt the microwire based upon the solid volume fraction determined at each point, and printing the microwire by projecting light at the scaled light power for each point to form a printed part. The solid volume fraction is a percentage of a defined volume that includes a solid material.

In embodiments of the above, the microwire is deposited at a deposition point and the deposition point of the microwire is the center point of a surface of the defined volume. In further embodiments, the defined volume includes at least one of a hemisphere, a sphere, a rectangular prism, a pentagonal prism, a cuboid, a dodecahedron, and an icosahedron.

In any of the above embodiments, the solid material includes at least one of 1) one or more previously printed layers, 2) a print surface, 3) a repair component, and a partial component.

In any of the above embodiments, the method further includes modifying the tool path to reduce distortion in the printed part by adjusting at least one of the following: 1) a fill pattern, and 2) a fill sequence.

In any of the above embodiments, the method further includes adjusting at least one of: a speed at which a nozzle is moved between two adjoining points, a speed at which the microwire is fed between the two adjoining points, a temperature of the nozzle, a temperature of a part heater, a temperature of a print bed, a power density of the light source between the two adjoining points, a power distribution of the light source between the two adjoining points, and a degree of symmetry of power distribution of the light source between the two adjoining points, wherein adjusting is based on at least one of: a characteristic of material present in the defined volume, relative mass of each material present in the defined volume if more than one material is present, and relative proximity of each material the defined volume if more than one material is present, wherein the characteristic includes at least one of: thermal conductivity, thermal expansion, and heat capacity.

In any of the above embodiments, the tool path includes one or more portions and each of the one or more portions exhibit a similar solid volume fraction and the method further comprises printing the one or more portions before printing other portions of the tool path, wherein similar solid volume fractions are within ten percent of each other. In further embodiments, the similar solid volume fractions of each of the one or more portions of the tool path are relatively higher than a solid volume fraction of each of the other portions of the tool path.

In any of the above embodiments, printing further includes feeding microwire through a print nozzle, projecting light onto a substrate at the scaled light power for each point, creating a melt pool on the substrate, melting the microwire, and depositing the microwire. In further embodiments, the microwire is melted by at least one of 1) the melt pool, and 2) the projected light incident on the microwire.

According to various additional aspects, the present disclosure relates to a three-dimensional printer. The three-dimensional printer includes a controller. The controller is configured to execute instructions to: define a tool path for a three-dimensional part to be printed with a microwire, calculate a solid volume fraction for a plurality of points along the tool path, scale a light power of a projected light from a light source, projected to melt the microwire based upon the solid volume fraction determined at each point, and print the microwire at the scaled light power for each point. The solid volume fraction is a percentage of a defined volume that includes a solid material.

In embodiments of the above, a center point of a surface of the defined volume is a deposition point of the microwire.

In any of the above embodiments, the defined volume includes at least one of a hemisphere, a sphere, a rectangular prism, a pentagonal prism, a cuboid, a dodecahedron, and an icosahedron.

In any of the above embodiments, the solid material includes at least one of 1) one or more previously printed layers, 2) a print surface, 3) a repair component, and a partial component.

In any of the above embodiments, the controller is further configured to modify the tool path to reduce distortion in the part to be printed by adjusting at least one of the following: 1) a fill pattern, and 2) a fill sequence.

In any of the above embodiments, the controller is further configured to adjust at least one of: a speed at which a nozzle is moved between two adjoining points, a speed at which the microwire is fed between the two adjoining points, a temperature of the nozzle, a temperature of a part heater, a temperature of a print bed, a power density of the light source between the two adjoining points, a power distribution of the light source between the two adjoining points, and a degree of symmetry of power distribution of the light source between the two adjoining points, wherein the adjustment is based on at least one of: a characteristic of material present in the defined volume, relative mass of each material present in the defined volume if more than one material is present, and relative proximity of each material the defined volume if more than one material is present, and wherein the characteristic includes at least one of: thermal conductivity, thermal expansion, and heat capacity.

In any of the above embodiments, the tool path includes one or more portions and each of the one or more portions exhibit a similar solid volume fraction and the controller is further configured to print the one or more portions before printing other portions of the tool path, wherein similar solid volume fractions are within ten percent of each other. In further embodiments, the similar solid volume fractions of each of the one or more portions of the tool path are relatively higher that a solid volume fraction of each of the other portions of the tool path.

In any of the above embodiments, the controller is further configured to feed microwire through a print nozzle; project light onto a substrate at the scaled light power for each point; create a melt pool on the substrate; melt the microwire; and deposit the microwire.

In any of the above embodiments, the controller is further configured to shift the projected light to compensate for at least one of 1) a microwire geometry and 2) a print geometry.

### BRIEF DESCRIPTION OF DRAWINGS

The drawings described herein are for illustration purposes only and are not intended to limit the scope of the present disclosure in any way.

FIG. 1 illustrates a three-dimensional printed using directed energy deposition according to embodiments of the present disclosure.

FIG. 2 illustrates a close up of a light system of a three-dimensional printed using directed energy deposition, according to embodiments of the present disclosure.

FIG. 3 illustrates a close up of a print nozzle and energy focal region, according to embodiments of the present disclosure.

FIG. 4 illustrates a method of forming a three-dimensional printed part, according to embodiments of the present disclosure.

FIG. 5 illustrates a defined volume used to calculate a solid volume fraction, according to embodiments of the present disclosure.

FIG. 6 illustrates a method of forming a three-dimensional printed part, according to embodiments of the present disclosure.

FIG. 7 illustrates a method of forming a three-dimensional printed part, according to embodiments of the present disclosure.

### DETAILED DESCRIPTION

The following description is merely exemplary in nature and is not intended to limit the present disclosure, application, or uses. The use of terms such as “above,” “below,” “upper,” “lower,” “x-direction”, “y-direction”, “z-direction” or other like terms to describe a spatial relationship between various components or to describe the spatial orientation of aspects of such components should be understood to describe a relative relationship between the components or a spatial orientation of aspects of such components, respectively, as the device described herein may be oriented in other directions.

The present disclosure is directed to methods of developing process parameters and controlling the directed energy deposition process for depositing a print material including at least one of a metal, metal alloy, and metals alloyed with non-metallics, and a three-dimensional printer configured to print based on instructions created by the methods. A metal alloy may be understood as an alloy of two or more metal elements. The method includes developing the process parameters used by the three-dimensional printer to deposit print material based on the volume fraction of solid material under or surrounding a deposition point, i.e., the point where material is being deposited. While reference is made herein to printing three-dimensional parts, the parts include individual components, cladding, or depositing material onto a partially formed component. Further, while the present disclosure is directed to methods of printing using directed energy deposition, the methods described herein may be used in other three-dimensional printing processes, including, but not limited to fused deposition modeling, blown powder directed energy deposition, laser powder bed fusion, and electron beam powder bed fusion.

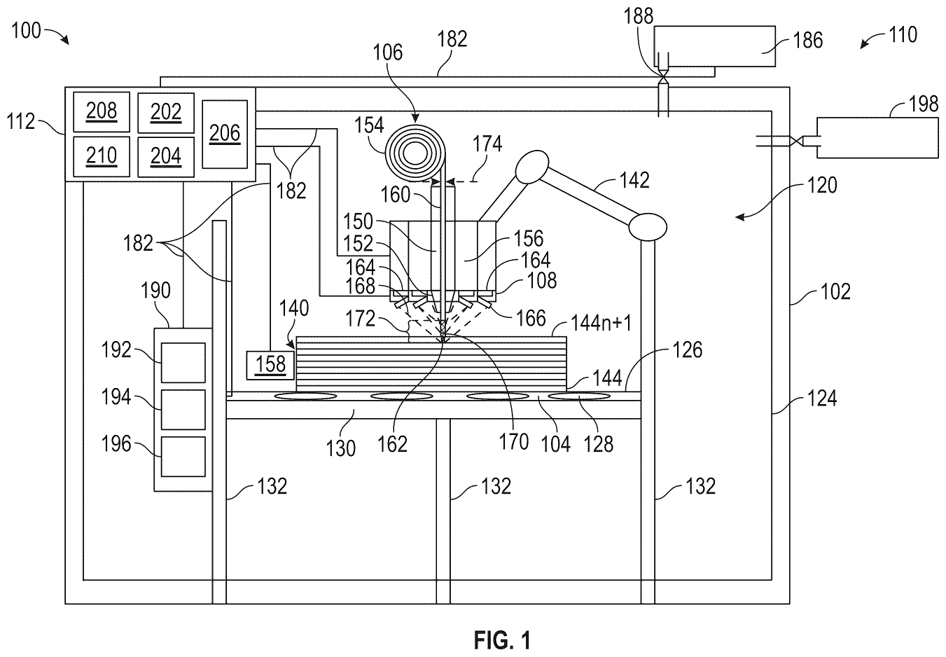

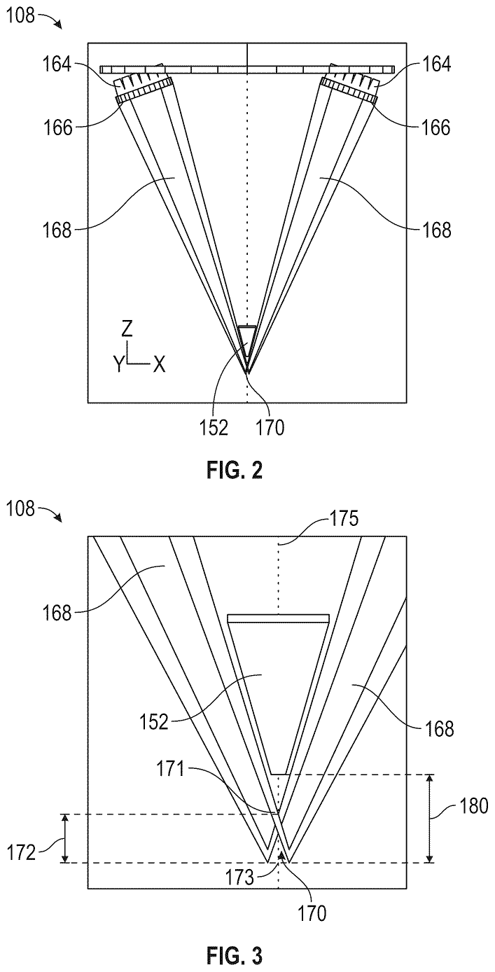

Turning now to FIGS. 1 through 3, these figures illustrate a general embodiment of a three-dimensional printer 100 using laser directed energy deposition for depositing a microwire to form a three-dimensional part 140. The microwire has a diameter 174 of 1 millimeter or less, such as all values and increments in the range of 0.1 millimeters to 1 millimeters and, in embodiments, 0.1 millimeters to 0.5 millimeters. The microwire includes a print material including at least one of a metal, metal alloy, and one or more metals alloyed with one or more non-metallic elements. A metal alloy is understood as an alloy including, consisting essentially of, or consisting of, at least two or more metal elements. The print material includes, but is not limited to, at least one of a transition metal, including but not limited to refractory metals such as niobium and tungsten, as well as transition metal alloys such as stainless steel, nickel-chromium alloys such as HAYNES 230, titanium based alloys, and refractory metal alloys.

The three-dimensional printer 100 generally includes a process chamber 102, a print bed 104, a feed system 106, a light system 108, an environmental control system 110, and a controller 112. The process chamber 102 encloses a volume 120 in which the print bed 104, at least a portion of the feed system 106, the light system 108, and at least a portion of the environmental control system 110 are located. In embodiments, such as the illustrated embodiments, the controller 112 is isolated from the volume 120 of the process chamber 102 to protect the electronic components therein from elevated temperatures or gasses that may be used in production. In alternative embodiments, the control system 112 may be included in the volume 120 of the process chamber 102. An access panel or door 124 provides access into the volume 120 of the process chamber 102. In yet further embodiments, the controller 112 is remote from the printer 100, such as in an external computer, and connected to the printer 100 through wired or wireless networks.

The print bed 104 is located in the enclosed volume 120 of the process chamber 102. The print bed 104 includes a print surface 126 that may be removable from the print bed 104. In embodiments, the shape of the print bed 104 and print surface 126 onto which the print material is deposited on may include any number of shapes, such as rectangular, circular, oblong, etc. In embodiments, the at least one of the print surface 126 and the print bed 104 is heated using one or more heating elements 128. Depending on the material that the print bed 104 is formed from, the heating elements 128 may be resistive heating elements, radiant heating elements, and induction heating elements.

In embodiments, the print bed 104 is mounted on a support bed 130 that is connected to one or more linear adjustment drives 132. Three linear drives 132 are illustrated, however up to eight linear drives 132 may be present, or more, depending on the expected weight of the printed three-dimensional part 140. The linear adjustment drives 132 raise and lower the print bed 104 relative to the print nozzle 150 of the feed system 106 and the light system 108. In embodiments, the linear adjustment drives 134 include at least one of a ball screw drive, a roller screw drive, and a linear motor. In alternative embodiments, the print bed 104 is stationary and the feed system 106 and the light system 108 are mounted to a feed system support 142, which is articulated relative to the print bed 104. In additional or alternative embodiments, the support bed 130 is a multi-axis turn table and the print bed 104 is mounted on the multi-axis turn table. Further, in embodiments, a partial part or a component to be repaired, i.e., a repair component, is mounted onto the print bed 104. In embodiments, the print surface 126, partial part, or repair component may form a non-planar surface onto which the print material is deposited.

The feed system 106 includes a print nozzle 150, a nozzle tip 152, and a microwire supply 154 such as the illustrated spool. The print nozzle 150, in embodiments, includes heaters 156 for preheating the microwire 160. Again, depending on the composition of the print nozzle 150 and the print material of the microwire 160, the heaters 156 may include one or more resistance heaters, induction heaters, and radiant heaters that heat either or both the print nozzle 150 and the microwire 160. The nozzle tip 152 extends down from the base of the print nozzle 150 towards the print bed 104. The nozzle tip 152 may also be heated using heaters 156 similar to those described above.

In embodiments, the feed system support 142 includes a robot arm configured to articulate the feed system 116 relative to the print bed 104 and the printed three-dimensional part 140. The feed system 116 provides at least two axis and up to seven axis of movement. In alternative embodiments, the feed system support 142 is a gantry that provides movement in a plane defined by two axis, the plane being at least one of 1) generally parallel to the print bed 104, and 2) orthogonal to the movement of the print bed 104 up and down relative to the print nozzle 150 and feed system 106.

The light system 108 includes an array of light sources 164 and one or more optical elements 166 to point the light 168 emitted from the light sources 164 to a focal region 170 on the microwire 160 and onto a substrate 144n+1. The substrate 144n+1 is understood as at least one of the print surface 126, a previously printed layer 144 (typically the last printed layer), a partial part, and a repair component. In embodiments, the light system 108 is mounted as a single unit surrounding the print nozzle 150 using a mechanical mount. Alternatively, the light system 108 may be mounted to the feed system support 142. In preferred embodiments, the light sources 164 include laser diodes, which are understood as semiconductor devices that emit light when provided with electrical current. In alternative embodiments, the light sources 164 may include light emitting diodes.

The light system 108 includes in the range of one to twenty light sources 164, including all values and ranges therein. In embodiments, the light sources 164 emit light in at least one wavelength in the range of 350 nanometers to 1100 nanometers, including all values and ranges therein, such as in the range of 400 nanometers to 500 nanometers, 450 nanometers to 750 nanometers, 700 nanometers to 950 nanometers, 890 nanometers to 1100 nanometers, etc. In embodiments, the light sources 164 may individually emit light in one or more wavelengths in the ranges of 400 nanometers to 500 nanometers, 450 nanometers to 750 nanometers, 700 nanometers to 950 nanometers, 890 nanometers to 1100 nanometers. In yet further embodiments, at least 65 percent or more of the light sources 164, and up to 100 percent of the light sources 164 present emit light exhibiting one or more electromagnetic wavelength in the range of 400 nanometers to 500 nanometers, including all values and ranges therein. The remaining light sources 164, to total 100 percent, exhibit one or more electromagnetic wavelengths in the range of 500 nanometers to 1100 nanometers including all values and ranges therein. In further embodiments, up to 35 percent of the light sources present emit light exhibiting one or more electromagnetic wavelengths in the range of 890 nanometers to 1100 nanometers including all values and ranges therein. The power and light intensity of each light source 164 may be individually adjusted allowing shifting of the light 168 incident on the microwire 160 in axis generally parallel to at least one of the substrate 144n+1 and the print bed 104 as well as generally orthogonal to at least one of the substrate 144n+1 and the print bed 104. In embodiments, such shifting may be used to compensate for at least one of microwire 160 geometry and print geometry.

Each light source 164 is aligned with an optical element 166 to point the light sources 164 to the focal region 170. In embodiments, a single optical element 166 is used for each light source 164. Alternatively, one or more optical elements 166 may be used for more than one of the light sources 164 wherein features are formed in the optical elements for each of the light sources 164.

In embodiments, the optical elements 166 are diffractive optical elements. Diffractive optical features may be provided for each light source 164. The diffractive optical features may be formed as a single optical element 166 associated with all the light sources 164, optical elements 166 associated with a plurality of the light sources 164, or optical elements 166 each associated with a single light source 164. The individual optical elements 166 may be at least one of cylindrical, spherical, and planar. Various materials may be used to form the diffractive optical elements 166 such as, but not limited to, BK-7. In additional or alternative embodiments, the optical elements 166 are reflective, the reflective optical elements include, but are not limited to, a curved mirror, a multi-facetted mirror, a smooth mirror, and combinations thereof. Similarly, the reflective optical features may be formed as a single optical element 166 associated with all the light sources 164, optical elements 166 associated with a plurality of the light sources 164, or optical elements 166 each associated with a single light source 164.

As illustrated in FIG. 1, among the light sources 164, the focal region 170 may be generally cylindrical in shape. Alternatively, non-cylindrical shapes may be used, such as frustoconical or conical. In embodiments, the focal region 170 may exhibit a height 172 in the range of 1 millimeter to 1.5 centimeters, and a diameter 174 in the range of the diameter of the microwire up to 400 percent greater than the diameter 174 of the microwire 160. In further embodiments, at least a portion of the light sources 164 may shift in the direction of printing to begin preheating and melting the substrate 144n+1 and microwire 160 in the region where the microwire 160 will be deposited next. Shifting of the light sources 164 may be facilitated by turning one or more light sources 164 in the light source array on and off or altering the direction the optics point the light sources 164 in. In embodiments, up to 50 percent of the light sources may be shifted to points along a tool path ahead of the deposition point 162, such as in the range of 1 percent to 50 percent including all values and ranges therein, such as 1 percent to 25 percent or 1 percent to 10 percent.

In embodiments, the focal region 170 encompasses both 1) a portion near the end the microwire 160 proximal to the print bed 104 and 2) the substrate 144n+1, which, as noted above, may be understood as at least one of the last deposited layer, the print surface 126, a partial component, or a repair component, at the deposition point 162 of microwire between the center point of the bottom of the nozzle tip 152 where the microwire 160 exits the nozzle 150 and the substrate 144n+1 that the microwire 160 is being deposited on. In further embodiments, the distribution of the light in the focal region 170 exhibits a bell curve, wherein the greatest intensity of the light is in the center of the height 172 of the focal region 170 or the bottom third of the height 172 of the focal region 170, decreasing towards the ends 171, 173 of the focal region 170 along an axis 175 defined by the print nozzle 152. Alternatively, the distribution of the light in the focal region 170 may increase towards the substrate 144n+1. And, in further embodiments, the greatest light intensity may also be projected into the substrate such that most or all of the direct laser light lands on the substrate rather than the wire.

In embodiments, melting is seen in the substrate 144n+1 and a melt pool is created. For example, in embodiments where the substrate 144n+1 is the last deposited layer, the last deposited layer 144n+1 melts proximal to the focal region 170. The melt pool then melts the microwire 160. In additional or alternative embodiments, melting may be seen near the end of the microwire 160 proximal to the substrate 144n+1. As illustrated in FIG. 3, in embodiments, the focal region 170 is a distance 180 in the range of 3 millimeters to 5 millimeters from the end of the nozzle tip 152. In embodiments, the focal region 170 may be further away from the nozzle tip 152, such as greater than 5 millimeters, to reduce heat introduced into the nozzle at the expense of wire location stability.

The environmental control system 110 includes a gas supply 186 for supplying inert gas into the volume 120 of the process chamber 102. In embodiments, the inert gas includes argon. Alternatively, the inert gas includes nitrogen or helium. The inert gas may be recirculated through the environmental control system 110, filtering the gas and regulating gas temperature as it recirculates. In additional or alternative embodiments, rather than supplying an inert gas, a reactive gas may be supplied after deposition of the printed three-dimensional part 140 is complete. Such reactive gas may be used to create a passivation layer on the surfaces of the printed three-dimensional part 140. In further embodiments, the gas supply 186 includes at least one of a regulator and a mass flow controller 188 for delivering gas at either a desired pressure or flow rate, respectively, to the process chamber 102.

Further, in embodiments, the environmental control system 110 also includes a temperature controller 190 for controlling the temperature of the volume 120 or part in the process chamber 102. The temperature controller 190 includes a temperature sensor 192 for measuring the temperature in the volume 120 of the process chamber 102. The temperature controller 194 also includes a heater as well as a fan 196 moving air or gasses around the process chamber 102. The temperature controller may also control part heaters 158 such as resistive heating elements, inductive heating elements, or radiant heating elements.

In yet further embodiments, the environmental control system 110 also includes a vacuum 198 for removing gas from the process chamber 102. The vacuum 198 may be a one stage vacuum or two stage vacuum including both a high-pressure and a low-pressure vacuum stage. A valve 199 may be provided between the process chamber 102 and the vacuum 198. In embodiments, the process chamber 102 may be brought to a vacuum in the range of 70 kPa to 1×10-12 Pa, including all values and ranges therein such as 70 kPa to 1×10-6 Pa, 30 kPa to 1×10-2 Pa, etc.

The controller 112 receives or generates print instructions, in the form of executable code, which is programmed either in the controller 112 using computer aided machining (CAM) software or derived from a computer aided design (CAD) model file into computer aided machining (CAM) software. In embodiments, the instructions are coded by one or more of a number of programming languages including, but not limited to, at least one of the following: C #, C++, Python, and Java. The controller 112 includes hardware, firmware, and software for parsing, analyzing, and modifying computer numerical control code and providing executable code for the printer 100. The controller 112 is preprogrammed to execute code or instructions to perform, for example, operations, acts, tasks, functions, or steps coordinating with other devices and components to perform operations when needed. The controller 112 includes one or more processors 202 that executes executable code to control the various functions of the three-dimensional printer 100, including the methods described herein. The executable code is stored in one or more tangible, non-transitory memory devices 204 accessible to the controller 112. Other information stored in the tangible, non-transitory memory device 204 includes characteristics of the print material including thermal conductivity, thermal expansion, laser absorption coefficient, and heat capacity. The tangible, non-transitory memory device 204 may also include predetermined process parameters based on the print material, such print nozzle 150 temperature ranges, print bed temperature ranges, radiant energy or radiant energy density ranges of the light system 108, print speed ranges used by the microwire feed system 116, and a temperature range for heater 158.

The controller 112 is connected to the heating elements 128 in the print bed 104 and any related temperature sensors, the linear adjustment drives 132, the heaters 156 in the print nozzle 150 and any related temperature sensors, the feed system support 142, microwire feed system 116, the light system 108, environmental control system 110, and heater 158 for heating the portion of the three-dimensional part 140 that has been printed and any related temperature sensors, the modeled partial part, the measured partial part, or the modeled and/or measured repair component. The connections between the controller 112 and the other components in the printer are facilitated by conductive wires 182 or by wireless connections facilitated by radio frequency or optical communication protocols.

In embodiments, the controller 112 also includes one or more displays 206 and user inputs 208. The display 206 includes, in embodiments, an LCD display or one or more light emitting diodes (LEDs) of different colors representing a different machine status. User inputs include, in embodiments, keyboards, trackpads, touch screen displays, etc., that allow for the user to provide information into the controller 112. Further, the controller 112 also includes one or more communication devices 210 for connecting the controller 112 to external devices, such as external computers, smart phones, etc.

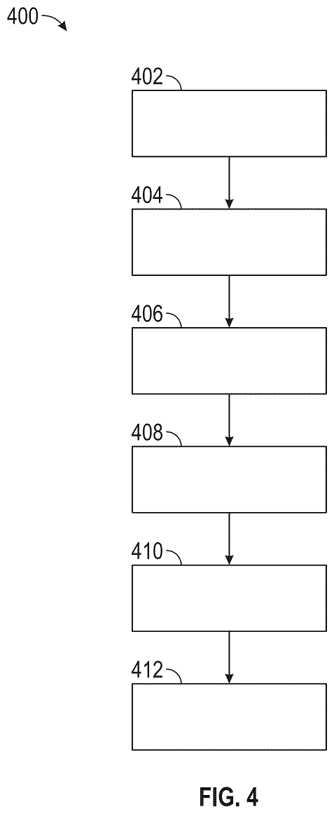

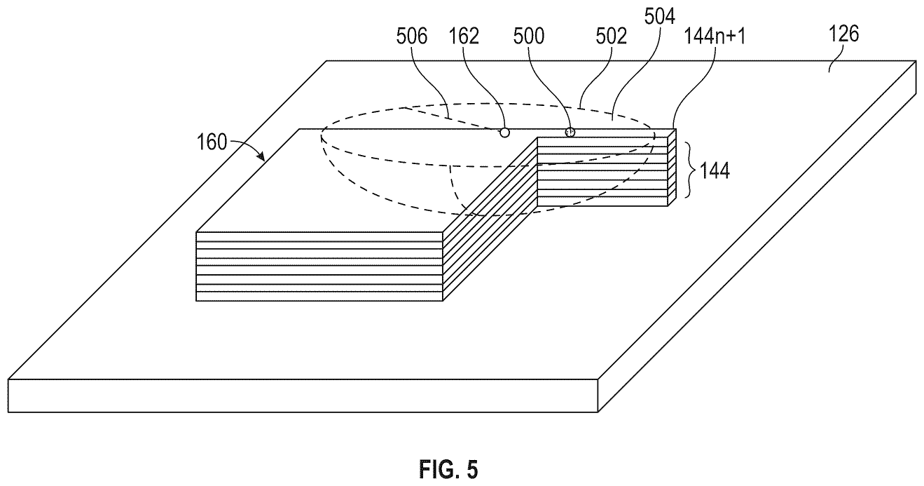

A method of printing a three-dimensional part 140 is illustrated in FIG. 4 with further reference to FIGS. 1 through 3. At block 402 a CAD file (or other file) representing a three-dimensional part 140 to be printed, such as a part, a repair section, or cladding, is received by the controller 112. At block 404 tool path planning software is used to define a tool path for the printer 100 to execute. The tool path may be either two dimensional tool paths, or three-dimensional tool paths. The tool path planning software generates computer numerical code, such as G-code, which includes instructions that tells the controller 112 the speeds, temperatures, and power the printer 100 and various components therein should operate at. With reference to FIG. 5, the computer numerical code includes instructions for the various components of the printer 100 embodying desired process parameters during movement of the print nozzle 150 between two points 500, 162 including at least one of the following: the speed at which the nozzle 150 is moved between the points, the speed at which the microwire 160 is fed between the points, the temperature of the nozzle 150, the temperature of the part heater 158, the temperature of the print bed 126, the power of the light source 108, the power density of the light source 108, the power distribution of the light source 108, the degree of symmetry (or asymmetry) of power distribution of the light source 108, etc. The points 500, 162 may be defined by at least one of 1) a change in process parameters, such as changes in speed, direction, temperature, power, etc., and 2) given intervals of distance along the tool path, wherein the intervals of distance may be in the range of 0.01 millimeters to 1 millimeter, including all values and ranges therein.

At block 406, a combination of planned tool paths and model geometry from the CAD file are used to calculate a solid volume fraction for each point along the tool path. As illustrated in FIG. 5, a solid volume fraction is understood as the percentage of a defined volume 502 that includes a solid material, such as at least one of previously printed layers 144, the print surface 126, a repair component, and a partial component, including the deposition point 162 as the center point of the top surface 504 of the defined volume 502. In the illustrated embodiment, the defined volume 502 is hemispherical and includes the substrate 144n+1, i.e., the last printed layer, the previously printed layers 144, and the print surface 126. However, in other embodiments, the defined volume 502 includes at least one of the substrate 144n+1 (as defined above), at least one previously printed layer 144, the print surface 126, a portion of the repair component, and a partial component. While a hemispherical defined volume 502 is illustrated, the defined volume 502 used to calculate the solid volume fraction may include, but is not limited to, a spherical, square, rectangular prism, hexagonal prism, pentagonal prism, cuboid, dodecahedron, icosahedron, etc. In the illustrated embodiment, deposition point 162 exhibits a greater solid volume fraction than deposition point 500.

If the entire defined volume 502 includes a solid material, for example, then the solid volume fraction is 100 percent, and if the entire defined volume 502 includes only 10 percent of solid material, then the solid volume fraction is 10 percent. As the solid volume fraction is reduced, the laser power needed to melt the microwire may be reduced. Stated another way, the laser power is scaled depending on the solid volume fraction. In embodiments, if the solid volume fraction is 100 percent, then the laser power needed to melt the microwire 160 may be 100 percent of the power range known to melt the microwire 160, determined through performing calculations or testing. Along an edge of a printed part where 50 percent of the defined volume 502 may be solid, the solid volume fraction would be 50 percent, and 50 percent of the power of the power range known to melt the microwire 160 may be needed to melt the microwire 160. In keeping with the same example, as the tool path approaches a corner, the required power may be even less than 50 percent of the power range known to melt the microwire 160, such as in the range of 10 percent to 49 percent of the power. The radius 506 of the defined volume 502 as measured from the deposition point 162, in the case of the hemisphere or sphere, is selected based on at least one of the print material thermal conductivity, the speed of the nozzle 150 as it traverses the points in the tool path, and the speed of the microwire 160 as it is being fed through the nozzle 150. The size of defined volume 502 for non-hemispherical or spherical volumes as measured from the deposition point 162 is similarly selected based on at least one of the print material thermal conductivity, the speed of the nozzle 150 as it traverses the points in the tool path, and the speed of the microwire 160 as it is being fed through the nozzle 150.

Optionally, at block 408, the tool path is modified to optimize the tool path, or otherwise adjust the tool path, from the originally defined tool path. Modifications include, but are not limited to, start and stop positions to improve surface finish in sections having different thicknesses, adjusting fill pattern to control at least one of cooling rate and distortion, and adjusting fill sequence to control at least one of cooling rate and distortion. At block 410, the process parameters used to print the microwire are adjusted based on the solid volume fraction calculations. In embodiments, adjusting the process parameters takes into account at least one of the following factors in addition to the solid volume fraction: materials (at least one of the printing material (or microwire), print surface material 126, the repair component material, and the partial component material) present in the defined volume 502, relative mass of each of the materials present in the defined volume 502, relative proximity of each material in the defined volume 502 to the deposition point 162, the characteristics of the materials present in the defined volume 502 such as the thermal conductivity, thermal expansion and heat capacity. In embodiments, the process parameters are adjusted to achieve one or more of the following: melting of the microwire 160 in the melt pool located at deposition point 162, controlling the size of the melt pool, preventing overheating of previously deposited layers proximal to the deposition point 162, and controlling the cooling rate of the deposited layers. If it is determined, based on the calculations, that the thermal conductivity of the mass in the defined area is insufficient to dissipate heat at a rate sufficient to prevent the melt pool from becoming too large, the power of the light source 108 may be reduced or the print speeds (the speed at which the microwire 160 is fed into the nozzle 150 and the speed the nozzle 150 is moved) may be increased to allow additional cooling of the mass in the defined volume 502 between passes of the print nozzle 150 and deposition of an additional layer of print material. At block 412, the modified process parameters and instructions for the tool path (if modified) are executed by the printer 100 to form a three-dimensional part 140.

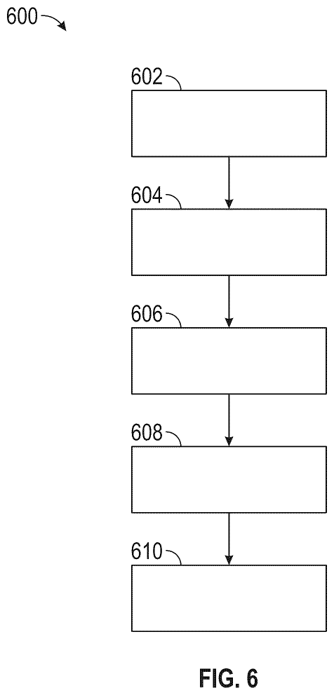

In an alternative or additional embodiment, a method of printing a three-dimensional part 140 is illustrated in FIG. 6 with further reference to FIGS. 1 through 3 and 5. At block 602 a CAD model (or other file) representing a three-dimensional object to be printed, such as a part, a repair section, or cladding, is received by the controller 112. At block 604 the solid volume fraction is calculated as discussed above with reference to FIG. 5 at points along the tool path to determine regions or portions of the tool path that exhibit similar solid volume fraction. For example, similar solid volume fractions may be volume fractions of portions of the tool path that are within a few percentage, within plus or minus 10 percent of each other. Each portion includes two or more points in the tool path. At block 606 similar regions are used to plan and adjust tool paths. For example, thinner sections, such as those similar in solid volume fraction to deposition point 500, may be printed before, or after, printing thicker sections such as those similar in solid volume fraction to point 162, which may assist in increasing dimensional stability, increasing dimensional accuracy, and reducing residual stress. At block 608 define and adjust process parameters at points along the tool path based on the solid volume fraction calculations in a manner similar to that described above with reference to FIG. 4. At block 610, the modified process parameters and instructions for the tool path (if modified) are executed by the printer 100.

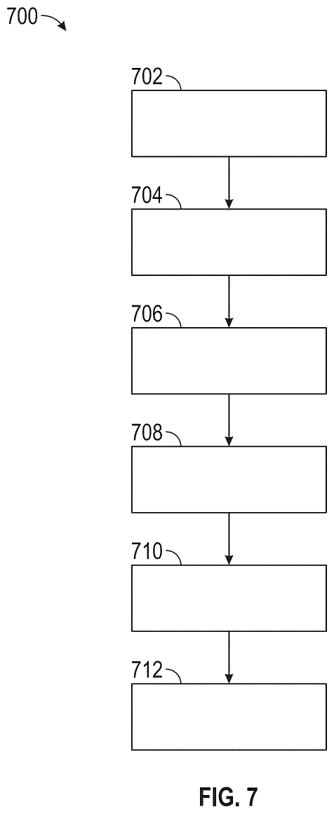

A method of printing the three-dimensional part and executing the modified process parameters and instructions for the tool path as described with reference to FIG. 4, block 412, and FIG. 6, block 610, is illustrated FIG. 7. At block 702 microwire 160 is fed through the print nozzle 150. Optionally, the microwire 160 is pre-heated in the print nozzle 150 at block 704. At block 706 the microwire 160 exits the nozzle tip 152, light 168 is projected onto the substrate 144n+1 as well as onto the microwire 160 from the light sources 164 through the optical elements 166. At block 708, the substrate 144n+1, such as the previously deposited layer, is heated with the light sources forming a melt pool. The microwire 160 is melted by at least one of 1) the melt pool created when heating the substrate 144n+1 and 2) light incident on the microwire 160 from the light sources 164 to form a melted print material. In embodiments, the deposited portion of the three-dimensional part 140 (if present) is also heated through a heater 158 using resistive heating, induction heating, or radiant heating. A clamp may be used to secure the three-dimensional part 140 to the print surface 126, which may be used to conduct heat to the three-dimensional part 140. In yet further embodiments, where a partial part or a repair component is mounted onto the print bed 104, the partial part or repair component may be preheated, melted by the light sources 164, or both preheated and melted by the light sources 164 in a manner similar to a printed three-dimensional part 140. At block 710 the melted print material is deposited onto the substrate 144n+1. At block 712, the melted print material solidifies.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 112 may also consist of multiple controllers which are in electrical communication with each other. The controller 112 may be inter-connected with additional systems and/or controllers of the three-dimensional printer 100, allowing the controller 112 to access data such as, for example, speed, acceleration, temperatures, pressures, and various other process characteristics of the three-dimensional printer 100.

A processor 202 may be a custom made or commercially available processor, a central processing unit (CPU), a graphics processing unit (GPU), an auxiliary processor among several processors associated with the controller 112, a semi composite conductor-based microprocessor (in the form of a microchip or chip set), a macroprocessor, a combination thereof, or generally a device for executing instructions.

The tangible, non-transitory memory 204 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 204 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 112 to control various systems of the three-dimensional printer 100.

The communication device 210 includes one or more interface circuits. In some examples, the interface circuits include wired or wireless interfaces that are connected to a local area network (LAN), the Internet, a wide area network (WAN), wireless local area networks (WLAN), cellular networks, or combinations thereof.

The methods and three-dimensional printer for executing the methods exhibit a number of advantages. These advantages include the ability to adjust process parameters along a planned tool path used to print a three-dimensional part based upon heat dissipation in the part. These advantages also include improvement in both geometric and microstructural consistency of printed parts, improving part robustness. These advantages further include improvement in yields and production time. These advantages yet also include a reduction in the need for closed loop process monitoring and control.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of printing a three-dimensional part, comprising:
defining a tool path for a three-dimensional part to be printed with a microwire in a printer;
calculating a solid volume fraction for a plurality of points along the tool path, wherein the solid volume fraction is a percentage of a defined volume that includes a solid material;
scaling a light power of a light source to melt the microwire based upon the solid volume fraction determined at each point; and
printing the microwire by projecting light at the scaled light power for each point to form a printed part.

2. The method of claim 1, wherein the microwire is deposited at a deposition point and the deposition point of the microwire is the center point of a surface of the defined volume.

3. The method of claim 2, wherein the defined volume includes at least one of a hemisphere, a sphere, a rectangular prism, a pentagonal prism, a cuboid, a dodecahedron, and an icosahedron.

4. The method of claim 1, wherein the solid material includes at least one of 1) one or more previously printed layers, 2) a print surface, 3) a repair component, and a partial component.

5. The method of claim 1, further comprising modifying the tool path to reduce distortion in the printed part by adjusting at least one of the following: 1) a fill pattern, and 2) a fill sequence.

6. The method of claim 1, further comprising:
adjusting at least one of: a speed at which a nozzle is moved between two adjoining points, a speed at which the microwire is fed between the two adjoining points, a temperature of the nozzle, a temperature of a part heater, a temperature of a print bed, a power density of the light source between the two adjoining points, a power distribution of the light source between the two adjoining points, and a degree of symmetry of power distribution of the light source between the two adjoining points,
wherein adjusting is based on at least one of: a characteristic of material present in the defined volume, relative mass of each material present in the defined volume if more than one material is present, and relative proximity of each material the defined volume if more than one material is present, and
wherein the characteristic includes at least one of: thermal conductivity, thermal expansion, and heat capacity.

7. The method of claim 1, wherein the tool path includes one or more portions and each of the one or more portions exhibit a similar solid volume fraction and the method further comprises printing the one or more portions before printing other portions of the tool path, wherein similar solid volume fractions are within ten percent of each other.

8. The method of claim 7, wherein the similar solid volume fractions of each of the one or more portions of the tool path are relatively higher than a solid volume fraction of each of the other portions of the tool path.

9. The method of claim 1, wherein printing further comprises feeding microwire through a print nozzle; projecting light onto a substrate at the scaled light power for each point; creating a melt pool on the substrate; melting the microwire; and depositing the microwire.

10. The method of claim 9, wherein the microwire is melted by at least one of 1) the melt pool, and 2) the projected light incident on the microwire.

11. A three-dimensional printer, comprising:
a controller, wherein the controller is configured to execute instructions to:
define a tool path for a three-dimensional part to be printed with a microwire;
calculate a solid volume fraction for a plurality of points along the tool path, wherein the solid volume fraction is a percentage of a defined volume that includes a solid material;
scale a light power of a projected light from a light source, projected to melt the microwire based upon the solid volume fraction determined at each point; and
print the microwire at the scaled light power for each point.

12. The three-dimensional printer of claim 11, wherein a center point of a surface of the defined volume is a deposition point of the microwire.

13. The three-dimensional printer of claim 11, wherein the defined volume includes at least one of a hemisphere, a sphere, a rectangular prism, a pentagonal prism, a cuboid, a dodecahedron, and an icosahedron.

14. The three-dimensional printer of claim 11, wherein the solid material includes at least one of: 1) one or more previously printed layers, 2) a print surface, 3) a repair component, and a partial component.

15. The three-dimensional printer of claim 11, wherein the controller is further configured to modify the tool path to reduce distortion in the part to be printed by adjusting at least one of the following: 1) a fill pattern, and 2) a fill sequence.

16. The three-dimensional printer of claim 11, wherein the controller is further configured to:
adjust at least one of: a speed at which a nozzle is moved between two adjoining points, a speed at which the microwire is fed between the two adjoining points, a temperature of the nozzle, a temperature of a part heater, a temperature of a print bed, a power density of the light source between the two adjoining points, a power distribution of the light source between the two adjoining points, and a degree of symmetry of power distribution of the light source between the two adjoining points,
wherein the adjustment is based on at least one of: a characteristic of material present in the defined volume, relative mass of each material present in the defined volume if more than one material is present, and relative proximity of each material the defined volume if more than one material is present, and
wherein the characteristic includes at least one of thermal conductivity, thermal expansion, and heat capacity.

17. The three-dimensional printer of claim 11, wherein the tool path includes one or more portions and each of the one or more portions exhibit a similar solid volume fraction and the controller is further configured to print the one or more portions before printing other portions of the tool path, wherein similar solid volume fractions are within ten percent of each other.

18. The three-dimensional printer of claim 17, wherein the similar solid volume fractions of each of the one or more portions of the tool path are relatively higher that a solid volume fraction of each of the other portions of the tool path.

19. The three-dimensional printer of claim 11, wherein the controller is further configured to:
feed microwire through a print nozzle;
project light onto a substrate at the scaled light power for each point;
create a melt pool on the substrate; melt the microwire; and
deposit the microwire.

20. The three-dimensional printer of claim 11, wherein the controller is further configured to shift the projected light to compensate for at least one of: 1) a microwire geometry and 2) a print geometry.
